(19) United States
(12) Patent Application Publication
(10) Pub. No.: US 2005/0249215 A1
(43) Pub. Date: Nov. 10, 2005

(54) Directing packets in a mesh network

(76) Inventors: Richard Andrews Kelsey, Arlington, MA (US); Matteo Neale Paris, Concord, MA (US); Robert Dunbar Poor, Cambridge, MA (US)

Correspondence Address: FISH & RICHARDSON PC, P.O. BOX 1022, MINNEAPOLIS, MN, 55440-1022, US

(21) Appl. No.: 11/062,514

(22) Filed: Feb. 22, 2005

Related U.S. Application Data
(60) Provisional application No. 60/545,977, filed on Feb. 19, 2004.

(51) Int. Cl. H04L 12/56

(52) U.S. Cl. 370/392; 370/238

(57) ABSTRACT

A wireless mesh network includes nodes of a first type and nodes of a second type. Packets are routed from nodes of the first type to nodes of the second type using a first routing protocol, and packet are routed from nodes of the second type to nodes of the first type using a second routing protocol that differs from the first routing protocol.

### CROSS-REFERENCE TO RELATED APPLICATIONS

This application claims the benefit of U.S. Provisional Application No. 60/545,977, filed Feb. 19, 2004, incorporated herein by reference.

### BACKGROUND

This invention relates to directing packets in a mesh network.

Wireless ad-hoc networks, which are typically self-organizing and which pass packets over multi-hop paths through the network, have been applied to a variety of applications. Various routing algorithms have been proposed for such networks, including Ad Hoc On-Demand Distance Vector Routing (AODV) and Dynamic Source Routing (DSR), in which packets are forward from node to node on a particular path from an origin node to a destination node. Another type of routing, called Gradient Routing, forwards packets without identifying each successive node in a path as a packet is retransmitted at intermediate nodes in the network. Some wireless networks are characterized by many nodes of one type that communicate with relatively few nodes of another type. For example, in a wireless sensor network, sensor data may flow from many sensor nodes to relatively few collection nodes and control data may flow from the collection nodes to some or all of the sensor nodes.

### SUMMARY

In one aspect, in general, the invention features a method, and an associated apparatus and software, for directing packets in a mesh network. The network includes nodes of a first type and nodes of a second type. Packets are routed from nodes of the first type to nodes of the second type using a first routing protocol. Packets are routed from nodes of the second type to nodes of the first type using a second routing protocol that differs from the first routing protocol.

The method can include one or more of the following features.

The network includes more nodes of the second type than nodes of the first type.

The second routing protocol includes storing a cost associated with sending a packet to a destination node of the first type, and transmitting a first packet to the destination node of the first type along a route of nodes. The route of nodes may be accumulated in the first packet.

The first routing protocol includes storing the route of nodes at a node of the first type, and transmitting a second packet to a destination node of the second type based on the route of nodes.

Transmitting the second packet includes skipping one or more nodes along the route of nodes.

The second routing protocol implements a gradient routing approach.

The first routing protocol implements one or more of a source routing approach, a data flooding approach, an ad hoc on-demand distance vector routing approach, or a dynamic source routing approach.

In another aspect, in general, the invention features a method for directing packets in a wireless mesh network. The method includes storing a route of nodes at a source node in the network, and transmitting a packet to a destination node in the network based on the route of nodes, including skipping one or more nodes along the route of nodes.

The method can include one or more of the following features:

A skipped node transmits an acknowledgement for the packet.

A node not on the route redirects the packet after a node on the route fails to receive the packet.

Aspects of the invention can include one or more of the following advantages:

Using a different routing protocol for transmitting from the first type of nodes to the second type of nodes than is used for transmitting from the second type of nodes to the first type of nodes improves performance of the network. For example, memory resources used by each node of the second type are reduced, reducing the memory resources used by the network.

In a source routed approach, allowing a packet to skip one or more nodes on a route improves efficiency of the network.

Retransmission of packets improves reliability of the network.

Other features and advantages of the invention are apparent from the following description, and from the claims.

### DESCRIPTION OF DRAWINGS

FIG. 1 is a diagram of a wireless network.

FIG. 2 is a diagram of a data packets for a gradient routing protocol.

FIG. 3 is pseudocode for a procedure to send a packet from a originating node.

FIG. 4 is pseudocode for a procedure to process a received packet.

FIG. 5 is pseudocode for a procedure to process a received packet at the destination node.

FIG. 6 is pseudocode for a procedure to process a received unicast packet at an intermediate node.

FIGS. 7A-B are pseudocode for a procedure to process a received broadcast packet.

FIG. 8 is a diagram of a wireless network with some nodes linked by a wired network.

FIG. 9 is a diagram of a zoned wireless network.

FIG. 10 is a diagram of data packets for source routing protocol.

### DESCRIPTION

Some routing protocols are more efficient than others for sending data from many nodes to relatively few nodes, or from relatively few nodes to many nodes. Some approaches described below are oriented to a network including relatively few nodes of a first type (e.g., collection nodes) and many nodes of a second type (e.g., sensor nodes). In these approaches a different routing protocol is used for transmitting from the sensor nodes to the collection nodes than is used for transmitting from the collection nodes to the sensor nodes. There may be, for example, a factor of 10 or 100 more sensor nodes than collection nodes. The network may also include other types of nodes, for example, three or more types of nodes, collectively using two or more different routing protocol.

In one example of use of different routing protocols, a gradient routing approach is used to send sensor data from many (e.g., 50,000) sensor nodes to relatively few (e.g., 500) collection nodes. The gradient routing approach is described in sections 1-4 below. A source routing approach is used to send control data from a collection node to a sensor node, as described below in sections 5-6. Alternatively, an algorithm such as data flooding, Ad Hoc On-Demand Distance Vector Routing (AODV), or Dynamic Source Routing (DSR) can be used to send data from a collection node to a sensor node.

### 1 Gradient Routing Approach

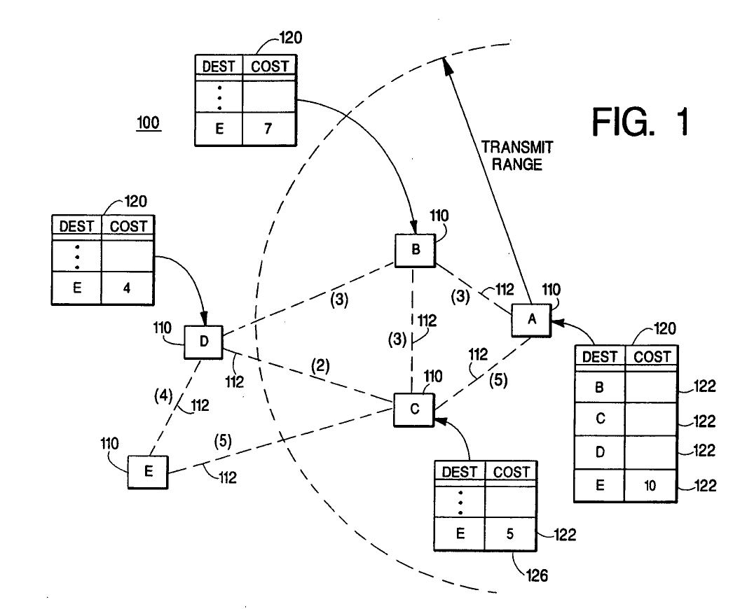

Referring to FIG. 1, a wireless network 100 includes a number of wireless nodes 110. In the example that is shown, nodes 110 are identified as nodes A-E. Not all pairs of nodes can necessarily communicate directly, and therefore data packets that pass through wireless network 100 generally take paths that pass through a number of intermediate nodes in a multi-hop routing approach. Routing of packets in wireless network 100 uses a gradient approach for sending data from a sensor node (e.g., node A) to a collection node (e.g., node E). Furthermore, in gradient routing an originating or intermediate node does not necessarily send each outgoing packet to a particular next node on a route to the ultimate destination for the packet. Rather, nodes transmit packets such that, in general, any of a number of nodes that receive the packet may forward the packet to its destination. As is described further below, the routing approach includes features that reduce the number of transmission needed to pass a packet from an origin node to a destination node.

In wireless network 100 shown in FIG. 1, nodes that are able to communicate directly with one another are indicated by a dashed line 112 joining the nodes. For example, nodes B and C are within node A's transmit range, and therefore can receive data from node A. In the discussion below, connectivity between nodes is generally assumed to be symmetrical (that is, for any pair of nodes, both nodes can receive transmissions from the other, or neither can). However, the version of the routing protocol described below will continue to function correctly in the presence of asymmetric links, as long as any two nodes are connected by a path consisting of symmetric links, and alternative versions of the routing protocol may not require such connectivity.

As part of the routing protocol, each node 110 maintains a cost table 120. Each cost table has a number of records (rows) 122, each row being associated with different particular destination node. Cost table 120 includes two columns: one column 124 identifies the destination, and another column 126 represents a cost of sending a packet from the node maintaining the table to the corresponding destination. The costs are positive quantities that represent that node's estimate of the lowest cost path through the network to the destination. The cost of a path includes additive terms corresponding to each of the links along the path. The cost of a link is inversely related to the link reliability. Reliability of a link can be estimated using any of a variety of techniques. For example, reliability of a link can be estimated by keeping track of the signal-to-noise ratio (SNR) of packets arriving at a node from a neighboring node over that link. In general, shorter links typically have lower cost because of the relatively higher signal strength than longer links. This version of the routing protocol does not rely on the link reliability being estimated as equal at the nodes of the link, and alternative versions of the protocol explicitly account for asymmetrical link reliability.

Any of a variety of physical (PHY) and media access control (MAC) layers may be used. In one implementation, nodes 110 communicate according to a proposed IEEE 802.15.4 standard. A direct sequence spread spectrum (DSSS) communication technique is used in the unlicensed 2.4 GHz ISM (Industrial, Scientific, and Medical) band. Use of spread spectrum communication avoids interference with other communication systems in the same band, including Bluetooth (IEEE 802.15.1) and Wireless LANS using the IEEE 802.11b standard. Alternative PHY and MAC layers that support concurrent transmission of packets from one node to multiple neighboring nodes can be used in an equivalent manner.

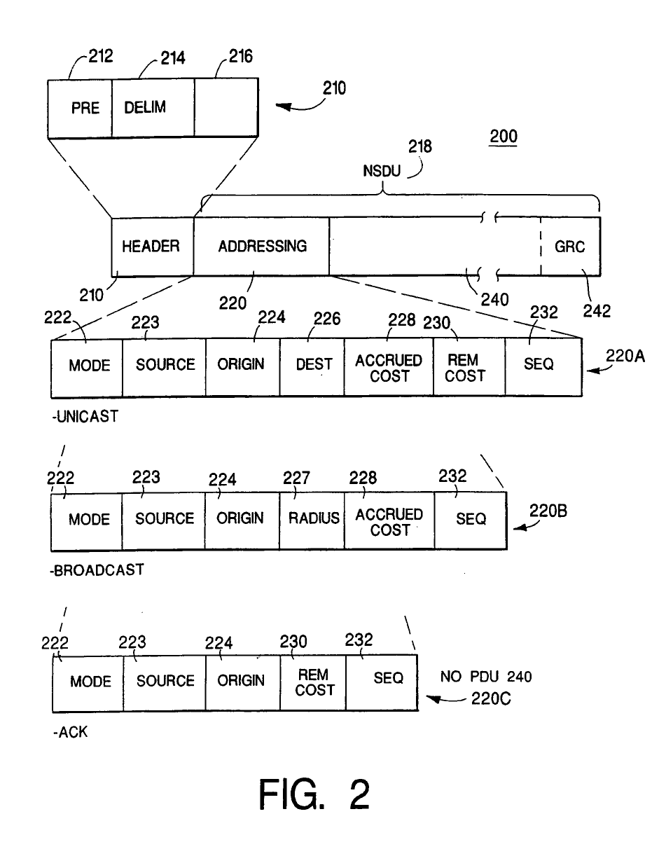

Referring to FIG. 2, data transmitted from sensor nodes to collection nodes use a packet format in which each packet 200 includes a physical layer header 210 and a remainder of the packet that forms a network service data unit (NSDU) 218. Header 210 includes a preamble 212, which is used for synchronization of the spread spectrum communication, a packet delimiter 214, and a packet length 216. NSDU 218 includes an addressing section 220 and a packet data unit (PDU) 240, as well as an optional CRC 242.

Addressing section 220 includes information that is used for routing packets through the network. Addressing section 220 includes a mode 222, which includes an indicator whether the packet is a unicast packet, broadcast packet, or an acknowledgment packet, and an indicator of whether intermediate nodes should update their cost tables based on this packet. As shown in the lower portion of FIG. 2, in addressing sections 220A-C, the format of the addressing section depends on the mode of packet.

For a unicast packet, addressing section 220A includes an identification of the origin node 224 and the destination node 226 for the packet, a sequence number 232 for packets sent from the origin node and an identification of source node 223 which transmitted the packet on the last link. In this version of the protocol nodes are identified by unique node numbers in a range 1-255. Addressing section 220 also includes an accrued cost 228 from the origin to the source and a remaining cost 230 from the source to the destination for the packet. The costs are represented as integers in a range 0-255. The procedure for setting the accrued and remaining costs is described further below.

For a broadcast packet, addressing section 220B does not include a destination, but rather includes a radius 227 is used to count the number of hops the packet has taken from its origin. As the broadcast packet is not addressed to a particular destination, the addressing section does not include a remaining cost field.

Addressing section 220C for an acknowledgment packet includes source 223, origin 224, remaining cost 230, and sequence number 232.

### 2 Examples

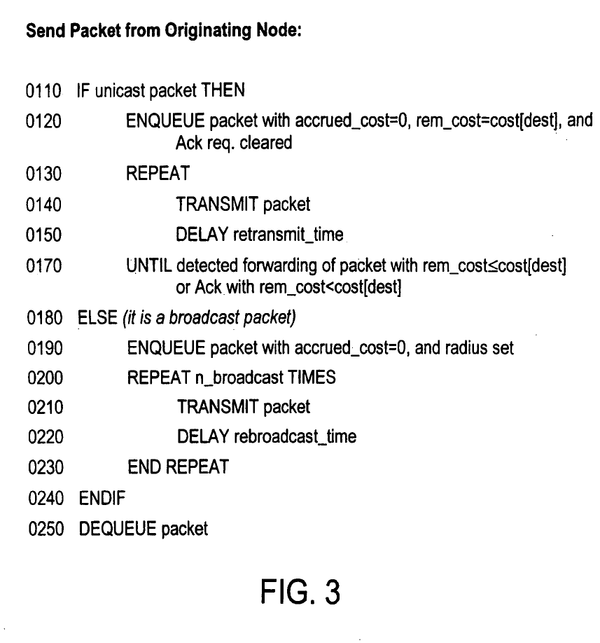

Several examples of packet forwarding according to the gradient routing approach are discussed below with reference to FIGS. 3 to 7A-B. These examples illustrate the procedures that are followed in transmitting and receiving packets according to the gradient routing approach. For simplicity, in the discussion below, a single “packet” is associated with a particular origin node and sequence number at that node. When a node is said to receive a packet, or multiple copies of the packet, this means that the node has received an instance of a packet with the particular origin node and sequence number. When important, the various instances (i.e., transmissions or retransmissions) of the packet are distinguished in the discussion. Note also that the procedures shown in FIGS. 3 to 7A-B each relate to processing a single packet. However, each node may concurrently process multiple packets according to the procedures.

### 2.1 Example 1

In a first example, a node A 110 transmits a unicast packet destined for node E 110. The packet is not flagged to update the cost tables as the packet traverses the network. In this example, each node of the network includes an record 122 in its cost table 120 for destination E. For illustration, link costs for the links are indicated in FIG. 1 in parentheses, and the minimum costs in cost table 120 at each node is the minimum total costs along the shortest path to destination E.

Source node A 110 initializes addressing section 220 of packet 200A destined for node E with its own identification in source node 223 and origin node 224 and node E's identification in destination node 226. Node A initializes accrued cost 228 to zero and remaining cost 230 to the cost to destination E retrieved from its cost table 120, which in this example is a cost of 10. This packet is flagged as a unicast packet that is not to be used to update cost tables. Node A increments its packet sequence number and puts that sequence number in sequence number field 232 and enqueues the packet in an outbound packet queue.

Referring to the procedure shown in FIG. 3, the packet is a unicast packet (line 0110) therefore originating node A 110 executes an initial sequence of steps at lines 0120-0170 in the procedure. First, node A passes the packet to a MAC layer for transmission (line 0140). Note that depending on the particular MAC and PHY layer, this step may in fact result in several attempted transmissions, for example, if collisions are detected when individual transmission are attempted.

The MAC layer does not provide a guarantee that the packet has been received by any neighboring node. Therefore, node A waits a retransmission time (line 0150). If before the expiration of the retransmission time, node A has either detected that another node closer to the destination has already forwarded the packet, or has received an explicit acknowledgement that the packet was forwarded by some node close to the destination (line 0170) then the node dequeues the packet (line 0250). As is discussed below, when a node forwards the packet, it re-writes the remaining cost field 230. By examining this field, node A can determine whether the node has indeed been forwarded by a closer node to the destination than itself. Similarly, explicit acknowledgement packets include a remaining cost field which is used for the same purpose. Node A repeats the steps of transmitting the packet and waiting (lines 140 150) until it detects the suitable forwarding or acknowledgment, or a retry limit is reached.

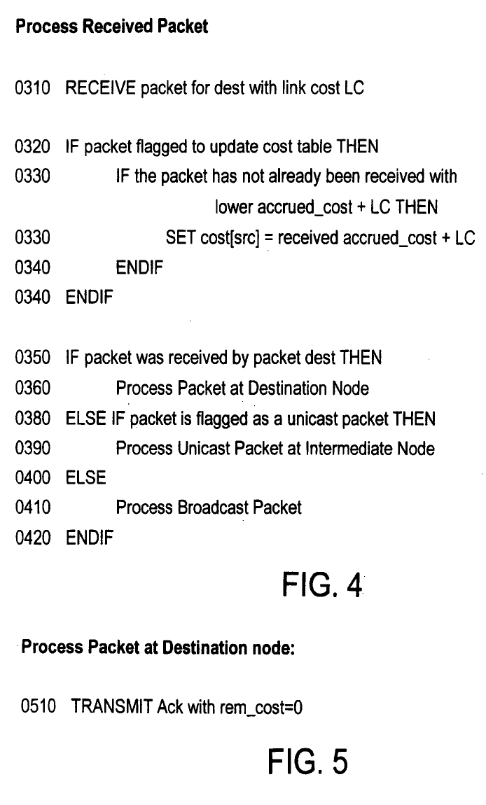

In this example, nodes B and C are in range of transmission from node A and both receive the packet. Referring to the procedure shown in FIG. 4, each node receives the packet and measures the received SNR, averaging it with SNR values previously detected from node A. The SNR is used to determine the link cost, LC. In this version of the system, the link cost is set to an integer in the range of 1 to 7.

If the packet is flagged to update the cost tables at receiving nodes (line 0320), the receiving node may update its cost table based on the cost of the reception. This updating procedure and the circumstances under which the node updates its cost table are discussed further below. In this example, the packet from node A is not flagged to update the cost tables and nodes B and C are not the ultimate destination of the packet and therefore processing of the receiving packet at each of nodes B and C continues at line 0350 with execution of the procedure to process a unicast packet at an intermediate node (line 0390).

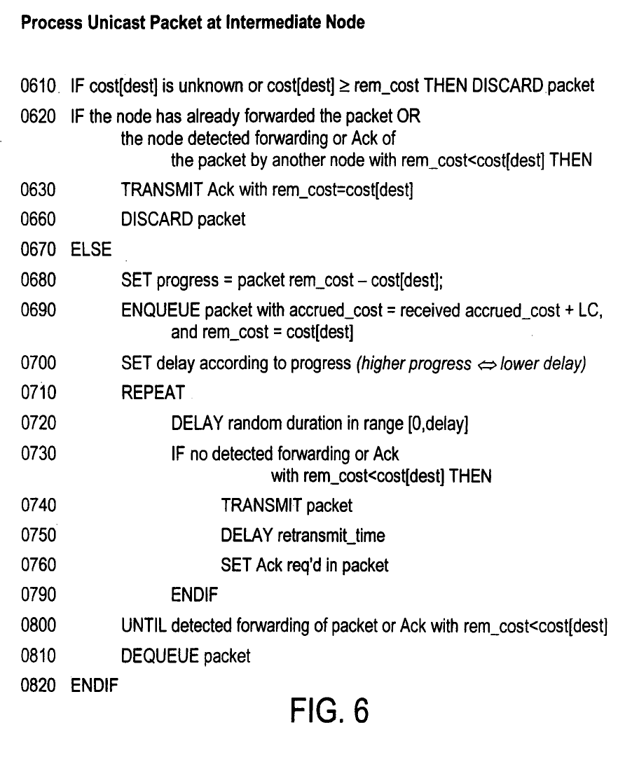

Referring to the procedure shown in FIG. 6, each intermediate node (i.e. nodes B and C in this example) that receives a packet first determines whether it should forward (retransmit) the packet, and if so delays retransmitting the packet for a period of time that depends on how much “progress” toward the ultimate destination the packet has made on its last transmission. Specifically, processing of the received unicast packet begins with a check to see if the receiving node has an entry in its cost table with the remaining cost to the destination of the received packet (line 0610). If the node does not have an entry, the node discards the packet without forwarding it. If it does have an entry, but its entry for the destination indicates that it is farther from the destination than the previous transmitter of the packet, then the node also discards the packet. In this example, both node B and node C are have lower remaining cost to destination E than is indicated in the received packet, and therefore neither discards the packet.

At this point in the example, on receiving the first transmission of the packet, neither node B nor node C has already forwarded the packet nor detected another node acknowledging the packet (line 0620) therefore processing of the received packet continues at line 0680.

Next each node computes the progress of the packet on its last hop (line 0680). The progress is defined as the difference between the remaining cost indicated in the received packet and the remaining cost in the cost table of the node computing the progress. A packet that has traveled on a higher cost link will in general have a higher computed progress. The progress of a packet is generally related to the cost of the reception on the last link (i.e., greater progress for lower SNR is typically corresponding to a longer distance), although due to variation in signal characteristics or dynamic changes in the cost tables, the progress is not necessarily equal to the last link cost.

Having computed the progress, nodes B and C then both enqueue the packet (line 0690). The accrued cost in the enqueued packet is incremented according to the last link cost, and the remaining cost is set equal to the node's entry in its cost table for the ultimate destination of the packet. Note that because the accrued cost is not actually used for routing decisions, updating the accrued cost is an optional step if the update costs flag is not set.

As introduced above, the packet is typically not transmitted immediately. Rather, each node next independently computes a maximum delay according to the progress made by the packet on the last transmission (line 0720). In this example, node B has a remaining cost of 7 to node E and therefore the progress of the packet, which has the remaining cost set to 10, is 3. Similarly, the progress of the packet at node C is 5. This maximum delay is based on the progress such that generally, the maximum delay is smaller when the progress is larger. This approach generally gives preference to paths with the fewer hops and reduces end-to-end latency. Note that nodes B and C do not have to coordinate their retransmission of the packet, and neither is necessarily aware that the other has also received and can forward the packet.

Each of the intermediate nodes B and C next performs a loop (lines 0710-0800) that is similar to the steps executed by the originating node (see lines 0130-0170 in FIG. 3). However, before transmitting the packet for the first time the node waits a random delay that is chosen from a uniform probability distribution ranging from zero to the maximum delay that was computed according to the progress of the packet. In this version of the system, the maximum delay is set equal to ½ to the power of the computed progress (typically in the range 1 to 7) times a fixed time constant, here 24 ms. Therefore, the maximum delay at node C with progress 5 is 0.75 ms., while the maximum delay for node B with progress 3 is 3.0 ms.

In this example, we assume that the actual delay for node C, which is chosen randomly, is indeed smaller than the chosen delay for node B. Therefore node C executes the test at line 0730 before node B to check whether it has detected any other node forwarding or acknowledging the packet. Because node C has not detected such a forwarding or acknowledgment, it transmits the packet (line 0740) and begins to wait for one retransmission time (line 0750) before determining whether to proceed with further retransmissions.

When node C forwards the packet, under the assumption that node B's chosen delay is longer than node C's, node B is still waiting to do so (line 0720). We assume that node B is in range to detect node C's forwarding of the packet. Therefore, at the end of the delay when node B would have transmitted the forwarded packet, it has detected the forwarding by node C. The remaining cost in that detected forwarding from node C is 5, the cost entry in node C's cost table for destination E. Because node B's entry for destination E is 7, which is greater than 5 (line 0750) node B is aware that a closer node to the ultimate destination has already forwarded the node, and that therefore it does not have to.

Returning to originating node A, and referring again to FIG. 3, we assume that node A detects node C's forwarding of the packet, and that the forwarded packet is transmitted by node C while node A is still in its retransmission delay (line 0150). Because the remaining cost in the forwarded packet is 5, which is less than node A's cost to the destination of 10 (line 0170) node A next dequeues the packet (line 0250).

Following the packet to its ultimate destination at node E, we assume that the destination node E, as well as other intermediate nodes A, B, and D are within range of node C's forwarding of the packet. Referring to FIG. 4, destination node E processes the packet transmitted from node C according to the illustrated procedure. In this example, the packet is not flagged to update costs, and therefore node E executes the Process Packet at Destination Node procedure (line 0360), which is illustrated in FIG. 5.

Referring to FIG. 5, this is the first time that node E has received this packet (line 0510), therefore node E immediately transmits an acknowledgement packet, with the remaining cost set to zero.

Nodes A and B each receive the packet forward by node C. However, both of these nodes have costs to node E that are greater than node C, and therefore both nodes discard the detected forwarded packet (line 0610, FIG. 6).

Node D receives the packet forwarded by node C. Node D has not detected the packet being forwarded by a closer node (line 0620) and therefore may need to forward the packet. Node D's cost to node E is 4, one less than the cost from node C, and therefore the progress is 1 (line 0680). The progress is relatively small, so the delay is relatively large (line 0700). Therefore, by the time that delay has expired (line 0720), node D has detected the acknowledgement packet sent by node E, with the remaining cost of zero, which by necessity is less than node D's cost to node E (line 0730). The packet node D received from node C does not indicate than an acknowledgment is required (line 0770) and therefore node D next dequeues the packet (line 0810).

At this point, in this example the packet has traversed from node A through node C to node E, without any unnecessary transmissions

### 2.2 Example 2

In the first variant of Example 1, we assume that node E actually managed to receive node A's original transmission, for example, because of a momentarily favorable transmission environment. We also assume that node E transmits an acknowledgement (line 0520, FIG. 5), but only nodes C and D detect the acknowledgment, not nodes A and B. Because node B has not received the acknowledgement from node E or any retransmission of the packet, node B then transmits the packet at the end of its random delay (line 0740). We assume that B's transmission is received by nodes A, C, and D.

Nodes C and D have already received the acknowledgement for the packet with a remaining cost of zero, and therefore discard node B's forwarded packet. However, because nodes C and D have already received acknowledgement for the packet, each node transmits an acknowledgement packet in response to receiving B's forwarded packet (line 0630). Node B receives these acknowledgments and therefore dequeues the packet (line 0810). Node A receives node B's forwarded packet, and therefore dequeues the packet as having been forwarded (line 0250).

### 2.3 Example 3

In a second variant of Example 1, node D receives node A's original transmission along with nodes B and C. Node D then forwards the packet before the other nodes and this forwarded packet is received by B, C, and E. Therefore nodes B and C do not forward the packet. We assume that node E's acknowledgment is received by nodes B, C, and D, but not by the originating node A. Therefore, at the end of the delay of the retransmission time (line 0150), node A does not know that the packet has made it to its destination, or that it has even been transmitted one hop. Therefore node A retransmits the original packet (line 0140).

When nodes B and C receive the retransmitted packet, they have already received the forwarded packet from node D with a lower remaining cost (line 0620, FIG. 6). Therefore nodes B and C transmit acknowledgments each indicating that node's cost to destination E in remaining cost field 230 of the acknowledgment. Node A receives at least one of these acknowledgements, and therefore dequeues the packet. 2.4 Example 4

Next consider an example of a broadcast packet originating at node A with the update cost flag not set. Referring back to FIG. 2, addressing section 220 of a broadcast packet includes radius field 227 rather than destination field 226. The value of the radius field is set to a positive number by the originating node and decremented by each forwarding node. A node forwards a broadcast packet only if the received value of the radius is greater than 1. Processing of broadcast packets at intermediate nodes differs depending on whether the update costs flag is set mode field 222 of addressing section 220.

Referring to FIG. 3, broadcast packets are first enqueued by the node for transmission indicating the desired radius of the broadcast (line 0190). The node then transmits the packet a predetermined number of times, delaying a fixed rebroadcast time between each transmission (lines 0200-0230) before it is dequeued. The node does not need to wait to detect the packet being forwarded. In this version of the system, the node rebroadcasts the packet three times (n_broadcast=3).

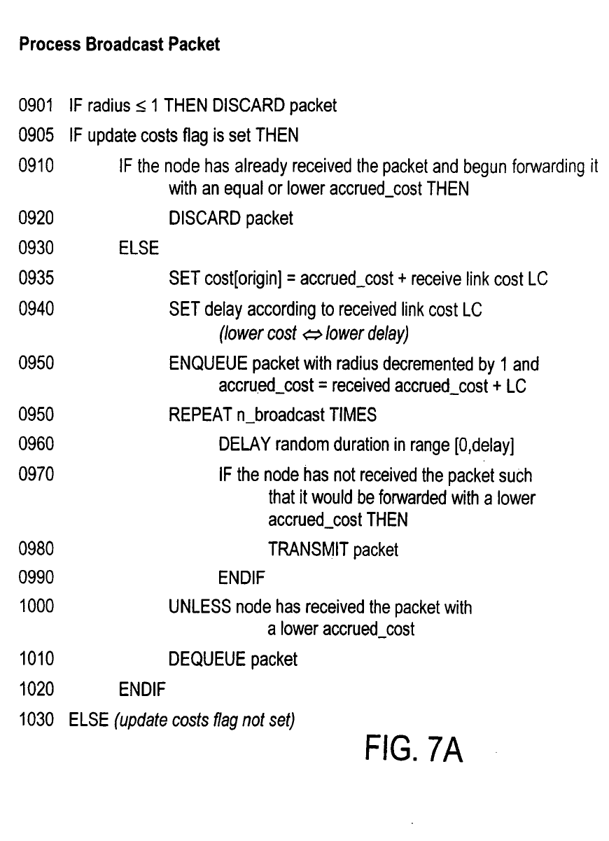

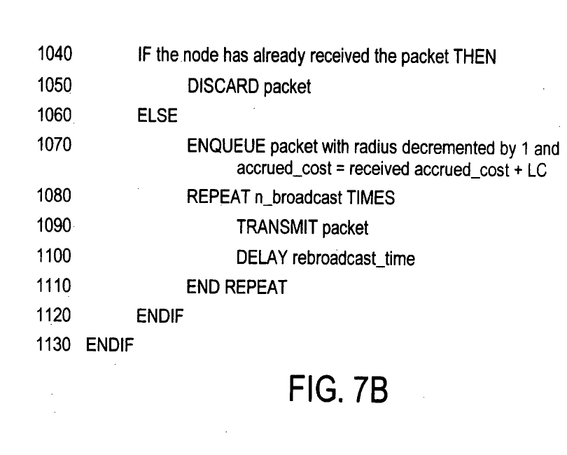

Each receiving node processes the packet according to the procedure shown in FIG. 7A. In general, nodes forward broadcast packets with a received radius greater than 1 after incrementing the accrued cost in the packet by the link cost of the link on which the packet was received and decrementing the radius by 1. The method of handling the packet depends on whether the update costs flag is set.

In this example, when nodes B and C each first receive the packet, because received radius is greater than 1 and the update costs flag is not set processing starts at line 1040. Nodes B and C have not previously received a copy of this packet, therefore both enqueue the packet after incrementing the accrued cost and decrementing the radius (line 1070) and initiate a loop (lines 1080-1110) retransmitting the packet. After forwarding the packet the fixed number of times, each node dequeues the packet.

Node D first receives the forwarded packet from one of nodes B and C first, and initiates the same forwarding procedure. When it receives the forwarded packet from the other of nodes B and C, it discards the packet (line 1050). 2.5 Example 5

Next consider an example in which a broadcast packet sent from originating node A with the update costs flag set. The procedure carried out by originating node A is as in the case when the update cost flag is set in Example 4.

In this example, when nodes B and C each first receives the packet, because received radius is greater than 1 and the update costs flag is set processing starts at line 0910. Nodes B and C have not previously received a copy of this packet, therefore processing continues at line 0935.

Each node updates its cost table for the cost of sending a packet from that node to the origin based on the received link cost plus the accrued_cost from the origin node (line 0935). In this example, on this reception, the accrued cost in the received packets from node A at nodes B and C is zero, and therefore nodes B and C both set their cost to A to be the received link cost of the packet just received from node A.

Each receiving node sets a delay according to the received link cost. Recall that the link cost is computed based on the signal characteristics of the transmission, and in this version is quantized to integer values from 1 to 7, with lower cost corresponding to a more reliable link. In this version of the system, the maximum delay is set to the cost minus 1 times a time constant of 4 ms. (line 0940). Therefore, delay for a cost of 1 is equal to 0 ms. while the delay for a cost of 7 is equal to 24 ms. Each node enqueues the packet (line 0950) and then waits for a random duration chose from a uniform distribution in the range from zero to the computed delay (line 0960).

During the process of forwarding a broadcast packet, the node may receive another copy of the packet. That second copy may have a different accrued cost indicated, and the link cost may be different than the first. In this version of the routing approach, if the node would forward the second copy with a lower accrued cost than the forwarding of the previous packet, the forwarding of the previously received copy of the packet is aborted if it has not already been completed. If the second copy would be forwarded with a higher or equal accrued cost, the packet is not forwarded. For example, if the node first receives the packet with an accrued cost a₁ with a link cost of c₁, forwarding of the packet indicates an accrued cost of a₁+c₁. If later, the node receives another copy of the broadcast packet which indicates an accrued cost of a₂ with a link cost of c₂, then that packet would be forwarded indicating an accrued cost of a₂+c₂. But if a₂+c₂≧a₁+c₁, then not only would the neighboring nodes have already received the packet, the second accrued cost from the origin node would be no lower and therefore the second copy of the packet is not forwarded.

Returning to the specific procedure illustrated in FIG. 7A, if at the end of the delay, an intermediate node has not received a copy of the packet that would be forwarded with a lower accrued cost (equal to the received accrued cost plus the link cost) (line 0970) it transmits the packet (line 0980). This delay and transmission is repeated for a predetermined number of times, in this version of the system, three times.

In this example, assume that node B receives the packet with cost 3 and node C receives the packet with cost 5. The maximum delay for node B is therefore 8 ms. while the maximum delay for node C is 16 ms. Assume that based on the randomly chose durations, node B forwards the packet first (line 0980) and node C receives the forwarded packet.

In this example, node C receives the second copy of the packet from node B with a cost of 3 and an accrued cost of 3 indicated in the packet. Therefore the new accrued cost of the packet if node C were to forward it is 6. But node C already has the packet queued with an accrued cost of 5, and therefore node C discards the packet from node B (line 0920).

Note that in principle, a unicast packet can also be sent with the update flag set. The result is that the cost entries for the origin node at a set of nodes “near” the shortest route to the destination are updated.

### 3 Layered Protocols

The gradient routing approach described above does not guarantee delivery of packets to their destination. Higher level protocols built on top of the network layer are responsible for features such as end-to-end acknowledgements it they are needed by an application. For example, request for an end-to-end acknowledgement may be included in the NPDU 240 (FIG. 2). When the ultimate destination of a unicast packet receives the packet, higher level protocol layers generate an acknowledgment packet for sending back to the origin.

At layers above the network layer, which is responsible for routing, a concept of a session is supported. If in the example network shown in FIG. 1, if node A wishes to communicate with node E, but it does not know the cost to send packets to E, or its cost is out of date, node A sends a broadcast packet that indicates that nodes should update their costs (to node A) when receiving the packet. The payload of the packet also includes a request of node E to establish a session. Node E in response to the request sends a unicast packet back to node A. This packet also has the update flag set. When node A receives node E's reply, the cost tables along the route support bi-directional communication between nodes A and E. As an alternative, node E's reply to node A is also a broadcast packet, thereby updating the cost to node E at a greater number of nodes of the network.

### 4 Alternatives

### 4.1 Routing Layer and MAC Layer Interaction

The MAC layer accepts one packet at a time for transmission, and returns a status code upon completion (either successful transmission or failure, for example, maximum CSMA back off reached). When transmitting a packet from the originating node, the MAC layer is allowed to transmit immediately. When transmitting a packet at an intermediate node, the MAC layer is instructed to select an initial random back off in order to avoid transmitting simultaneously with neighboring nodes. The initial backoff is treated independently of the progress-based forwarding delay. A useful, though not necessary, feature of the MAC is the ability to cancel a previously requested transmission. This feature is used by the routing layer to reduce unnecessary transmissions, for example, if an acknowledgement is heard for the packet being processed by the MAC (e.g., avoiding transmission at line 0740 if an acknowledgment is detected at line 0730).

### 4.2 Cost Averaging

In the cost updating approach described above, a node compute the received link cost based on the received signal-to-noise ratio of a single packet that is flagged to update costs. As an alternative, each node maintains a longer-term average of the cost of receiving packets from its neighboring nodes, and uses this average when it receives a packet flagged for it to update is cost table and to increment the accrued cost field of forwarded packets.

### 4.3 Proactive Cost Table Updates

Nodes can optionally exchange cost table information with their neighboring nodes, and use the received cost tables and received link costs to update their own tables. For example, rather than waiting for a packet with the update flag set to update an entry in its cost table to the origin node of that packet, the node receives one or more entries of a neighboring node's cost table. The receiving node adds the link cost for packets from the node that sent the entries to each of the costs in the entries. It then replaces any of the costs in its table for which the incremented received costs are lower.

### 4.4 Unidirectional Costs

In the cost update approaches described above, the cost at an intermediate node B for transmitting a packet to node A is set based on the accrued cost of sending packets from node A to node B. In systems in which the cost of transmitting packets is not symmetrical, an alternative approach may be desirable. Asymmetrical costs can occur for a number of reasons, including differences in transmission power at different nodes, or interference that is localized and affects different receivers to different degrees.

In this approach, each node periodically broadcasts a message with its radius field set to 1 that is received by its neighbors. Because the radius is set to 1, this message is not forwarded by these nodes. The message body includes a cost of receiving packets from each of the neighbors based on previous messages sent from those neighbors.

Each node maintains a table of link costs of receiving a packet transmitted by it at each of its neighbors. When a node B receives a packet from a node A that is flagged with the update costs flag, rather than adding the cost of the reception of that packet to the accrued cost indicated in the packet, it adds the cost of receiving packets at node A from node B from its table.

With this change in the update to the accrued cost, the cost table truly reflects the unidirectional cost of sending a packet to the destination node.

### 4.5 Communication Backbones

In an alternative approach, nodes may be linked by non-wireless links. For example, referring to FIG. 8 nodes A and E 810 include both a wireless and a wired interface and are linked by wired network 820, such as an Ethernet, MODBUS®, or a dedicated wired link. In the system, the routing and cost update algorithm described above functions as before, with the cost of communicating over the wired links being zero (or smaller than the cost of the wireless links). That is, at node A the costs in the cost table to communicate with node E is zero. In the example shown in FIG. 8, the cost of reaching node F from node E is 4 (B→A=2, A→E=0, E→F=2). When node B transmits a packet to destination node F, and this packet is received by nodes A, C and D, nodes A and C queue the packet for retransmission. Node A is cost 2 from node F so it is likely to retransmit first, which it does by passing the packet over wired network 820.

Note that should the wired network fail, connectivity between nodes B and F is maintained via the link between nodes C and F. In this way, a wireless network can serve as a backup for other nodes linked by a wired network.

### 4.6 Service Addressing and Service Discovery

In the approaches described above, addressing is according to identities of nodes in the network. In an alternative approach in which each node can host one or more of services, and packets are addressed to services rather than to nodes. Furthermore, the same service may be hosted at a number of different nodes. In this alternative, cost tables include entries that identify costs to send packets to the particular services. The routing algorithm then functions as described above. When a node needs a particular service, it sends a broadcast packet to that service, and a node listing that service replies, thereby locating the nearest node hosting the service.

### 4.7 Zoned Addressing

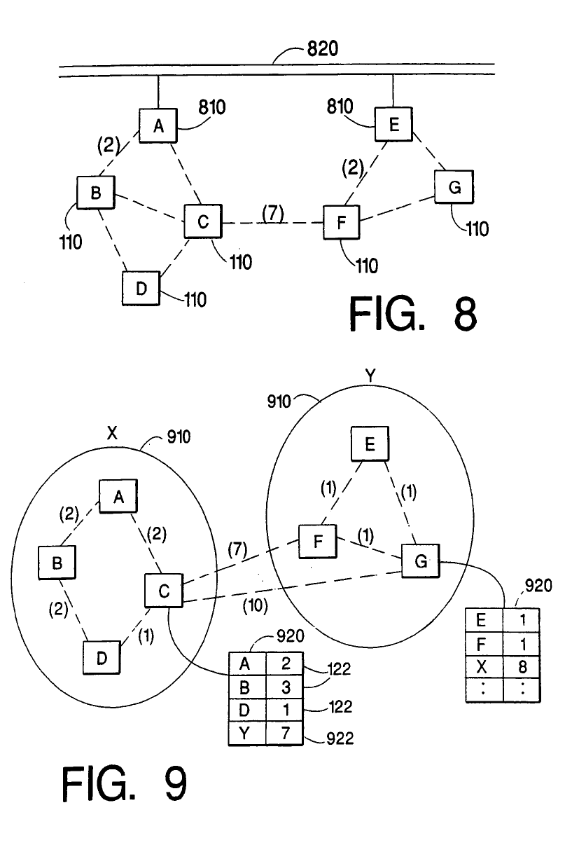

In another approach, nodes are arranged in zones. For example, part of a node identification (e.g., a prefix of a numerical address) may identify the zone that the node is a member of. In such an approach, a node may not explicitly maintain a cost to every possible destination node. Referring to FIG. 9, nodes A, B, C, and D are in a zone X 910, while nodes E, F, and G are in zone Y 910. Each node maintains a cost table 920, which includes records 122 that are associated with individual nodes in its zone, and also includes records 922 that are each associated with an entire zone. The cost associated with a zone is the minimum cost to any node in that zone.

The routing algorithm and cost update algorithm described above functions similarly, with an entry in a cost table for a zone reflecting the minimum cost to a node in that zone. That is, when a node wants to transmit a packet to a node in another zone, it uses the node's identification to determine that node's zone identification, and looks up the record in the cost table according to the zone identification.

In another variant of this approach, there may be multiple level hierarchy of zones, and the cost table at a node may include zones at different levels of the hierarchy.

### 4.8 Link Costs and Delay Computation

Other measurements of received signals can be used as the basis for computing link costs. In CDMA systems, the signal correlation values can be used instead of a direct measurement of signal-to-noise ratio. Similarly, an absolute signal level can alternatively be used. Digital error rates, such as bit or packet error rates, can also be used as the basis for determining link costs.

An alternative approach uses costs that are based on other factors than signal quality. For example, transmissions from a power-limited node may have a higher cost than similar transmissions from a node that is not power limited. In this way, packets are preferentially routed away from power-limited nodes. Other measures of link reliability can also be used. For example, if a link is known to be periodically unavailable or known to be unreliable, its link cost can be set higher than a continuously available link.

In the approaches described above, packet retransmission is typically delayed, in part to avoid unnecessary retransmissions or to avoid collisions. Alternative approaches can be used to compute the amount to delay a packet. For instance, a deterministic rather than random delay can be used. Also, the delay or its probability distribution can be based on factors such as the absolute cost to reach the destination, a next-link cost to the destination, a geographic distance of the last link or of the distance to the destination, available power at the node, pre-configured parameters such as parameters related to the desirability of forwarding packets, or characteristics of the packet such as a priority,

### 4.9 Combination with Other Routing Approaches

The gradient routing approach described above can alternatively be combined with explicit routing. For example, unicast packets can be explicitly addressed to a next node on the shortest path to the destination, and a receiving node that is explicitly addressed in this way then forwards the packet without delay. Because only one node is explicitly addressed in this way, multiple nodes will not immediately forward the node and therefore immediate collisions are avoided.

In this approach, nodes that receive the packet but that are not explicitly addressed act as backups to the node on the shortest path. Should the explicitly addressed node on the shortest path fail to forward the packet, these nodes that act as backups will forward the packet to make up for the addressed node's failure to forward the packet.

### 5 Source Routing Approach

A source routing approach is used to send data from a collection node (e.g., node E) to a sensor node (e.g., node A). The source routing approach makes use of “source routes” (i.e., routes provided by the origin node) for sending data from a collection node to a sensor node. This source routing approach uses a packet format similar to the format shown in FIG. 2, that is modified for unicast packets to include a path that the packet may take through the network. Note that, as described below, in at least some versions of the approach, the path is a “suggested” path in that the packet may in fact follow a somewhat different path to the destination.

### 5.1 Packet Format

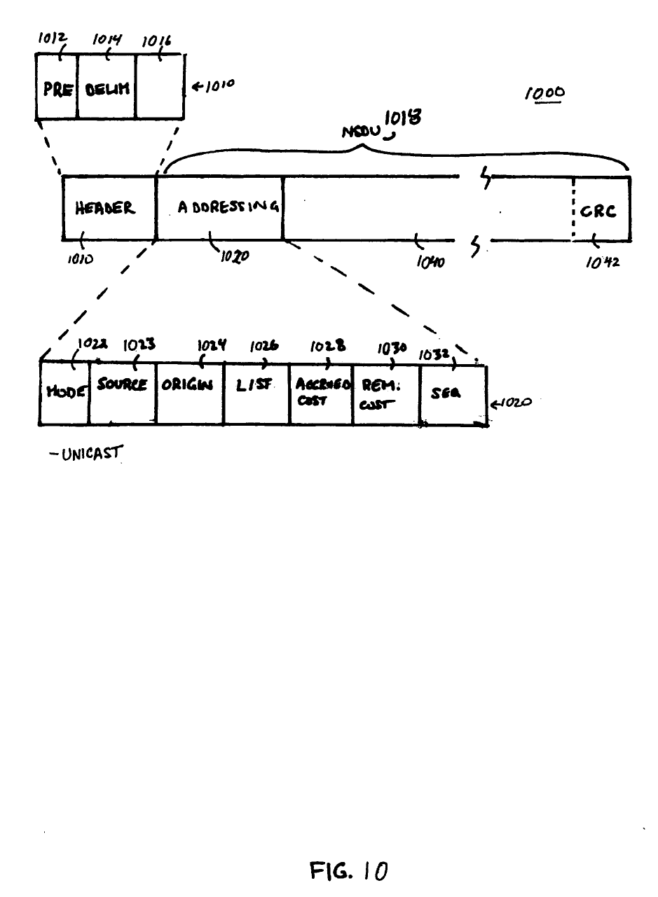

Referring to FIG. 10, unicast data transmitted from a collection node to a sensor node use a packet format in which each packet 1000 includes a physical layer header 1010 and a remainder of the packet that forms a network service data unit (NSDU) 1018. Header 1010 includes a preamble 1012, a packet delimiter 1014, and a packet length 1016. NSDU 1018 includes an addressing section 1020 and a packet data unit (PDU) 1040, as well as an optional CRC 1042.

Addressing section 1020 includes information that is used for routing packets through the network. Addressing section 1020 includes a mode 1022, which includes an indicator whether the packet is a unicast packet, broadcast packet, or an acknowledgment packet, an indicator of whether intermediate nodes should update their cost tables based on this packet, and an indicator of whether the packet is a source routed packet. The addressing section 1020 for broadcast and acknowledgement packets are similar to those (220B, 220C) shown in FIG. 2.

For unicast packets, the addressing section 1020 includes the origin node 1024 and list 1026 of nodes along a route to the destination node for the packet. The list 1026 may include only the destination node if the origin node is a neighbor of the destination node. The addressing section also includes a sequence number 1032 for packets sent from the origin node. The list 1026 of node identification numbers indicates a path that the packet may take through the network. However, the packet may skip one or more nodes along the indicated path if such transmissions of the packet between nodes on the list 1026 are successful. Since the packet may be used to update link costs, the addressing section 1020 also includes an identification of the source node 1023 which transmitted the packet on the last link, an accrued cost 1028 from the origin to the source, and a remaining cost 1030 from the source to the destination for the packet.

### 5.2 Packet Forwarding

A collection node (e.g., node E) sends a packet to a sensor node (e.g., node A) flagged as a source routed packet. A node receiving a source routed packet (e.g., a collection node, a sensor node, or another type of node) checks the packet to determine whether the receiving node's identification number appears on the list 1026. If so, the receiving node determines whether its identification number occurs before or after the identification number of the source node from whom it received the packet. If before, then the packet serves as an acknowledgement. If after, and the packet has not been received before, the packet is forwarded. If after, and the packet has been received before, the receiving node does not forward the packet but may optionally transmit an acknowledgement packet. For example, the receiving node transmits an acknowledgement packet with the remaining cost field 1030 set to the number of hops to the destination, as determined by the list 1026.

Optionally, the source routing approach can include a node that is not on the list 1026 participating in packet forwarding. For example, if a node's identification number does not appear on the list 1026, the node waits a predetermined amount of time to receive an instance of the packet from a node that is further on the list than the node from whom it received the packet. If no such packet is received within the time limit, then the node forwards the packet. This gives a packet a chance to be re-routed in case a node along the source route (i.e., a node on the list) fails.

Upon reception of an acknowledgement packet of a source routed packet, a node on the list 1026 uses this remaining cost field 1030 to determine whether the acknowledgement packet is from a node appearing before it or after it in the list 1026. In this scheme, a node may be skipped in relaying the source routed packet to the destination, but still participate in forwarding acknowledgement packets. Upon receipt of the packet, the destination node transmits an acknowledgement packet with a remaining cost of 0.

### 5.3 Route Tables

In one example, gradient routed packets are only used from sensor nodes to collection nodes, and source routed packets are only used from collection nodes to sensor nodes. In this scenario, cost tables (at either collection nodes or sensor nodes) only need to be populated with costs for sending packets to the relatively few collection nodes. A collection node stores (in addition to the cost table) a “route table” that includes lists of nodes along routes to a set of destination sensor nodes with which the collection node communicates. For example, sensor nodes may only communicate with the closest (i.e., lowest cost) collection node. Alternatively, a route table may include routes to all sensor nodes.

One approach to building up the route table at a collection node includes having the collection node send a broadcast packet that identifies one or more sensor nodes to which the collection nodes wants to establish a route. A sensor node sends a return (gradient routed) unicast packet to the collection node where the packet is flagged to accumulate a return route based on the nodes that relay the packet to the collection node. The accumulated route may or may not be the lowest cost route to the collection node, depending on the particular route taken by the first instance of the packet to arrive at the collection node.

In another approach to building up the route table at a collection node, a sensor node initiates communication with a collection node. The sensor node flags a (gradient routed) unicast packet to accumulate a route based on the nodes that relay the packet to the collection node. If the sensor node does not have a cost to the collection node, the sensor node may send a broadcast packet that notifies collection nodes to broadcast cost updates to the rest of the network.

Collection nodes may also send distribute routes that they have received to other collection nodes. Other approaches to building up the route tables at collection nodes are possible.

### 5.4 Potential Network Memory Use

Assuming there are N collection nodes and M sensor nodes, where N<M, potential memory use in the network is compared for an approach using gradient routing between all nodes, and an approach using gradient routing from a node sensor node to a collection node and source routing from collection node to a sensor node. In the first (gradient-routing-only) approach, each of N+M nodes in the network potentially stores a cost (and an associated address) to every other node in the network, leading to a potential memory use proportional to (N+M)². In the second (gradient routing/source routing) approach, each of N collection nodes potentially stores a route (each route including at most R addresses) to each of M sensor nodes, and each of N+M nodes in the network potentially stores a cost to each of N collection nodes. This second approach leads to a potential memory use proportional to RNM+N(N+M). This comparison reveals a large potential savings in network memory use when there are many more sensor nodes than collection nodes (i.e., M>>N), depending on the size of R. For example, the size of R may be O((N+M)^{1/2}).

### 6 Examples

Examples of packet forwarding according to the source routing approach are discussed below with reference to FIG. 1.

### 6.1 Example 1

In a first example, node E transmits a packet destined for node A that includes a list of nodes E-D-C-A (e.g., obtained from a previous packet send from node A flagged to accumulate a route). This packet is flagged as a source routed unicast packet that is not to be used to update cost tables. Node D receives and forwards the packet which is then received by node C and node E. Node E treats the packet from node D as an acknowledgement and does not retransmit the packet. Node C forwards the packet which is received at the destination node A. Node D treats the packet forwarded by node C as an acknowledgement, and node A sends an acknowledgement packet for node C.

### 6.2 Example 2

In a first variant of Example 1, node E transmits a packet destined for node A that includes the same list of nodes E-D-C-A. In this example, node D does not receive the packet from node E, but node C does receive the packet from node E. Since node C's identification number appears after node E's identification number on the list, node C forwards the packet which is received at the destination node A. In this example, a node along the source route is skipped.

### 6.3 Example 3

In a second variant of Example 1, node E transmits a packet destined for node A that includes a different list of nodes E-D-B-A. In this example, node D does not receive the packet from node E, but node C does receive the packet from node E. Since node C's identification number does not appear on the list, node C waits a predetermined amount of time to receive an instance of the packet from node B, D, or A. After not receiving an instance of the packet from any of these nodes within the time limit, node C forwards the packet which is received by node B. Node B then forwards the packet to the destination node A. In this example, a node not on the source route redirects the packet after a node on the source route fails to receive the packet.

### 7 Other Routing Protocols

Other routing protocols can be used to send data from a collection node to a sensor node and retain some or all of the advantages described herein. The source routing approach described above and other routing protocols that use “source routes” (e.g., DSR) do not necessarily require all of the many sensor nodes to store data (e.g., cost values) for every other node in the network. Other routing protocols include on-demand route discovery approaches (e.g., AODV) that also provide a way to direct packets from a collection node to a sensor node without necessarily requiring all of the many sensor nodes to store data for every other node in the network.

It is to be understood that the foregoing description is intended to illustrate and not to limit the scope of the invention, which is defined by the scope of the appended claims. Other embodiments are within the scope of the following claims.

1. A method for directing packets in a wireless mesh network that includes nodes of a first type and nodes of a second type, the method comprising:
routing packets from nodes of the first type to nodes of the second type using a first routing protocol; and
routing packet from nodes of the second type to nodes of the first type using a second routing protocol that differs from the first routing protocol.

2. The method of claim 1 wherein the network includes more nodes of the second type than nodes of the first type.

3. The method of claim 1 wherein the second routing protocol comprises:
storing a cost associated with sending a packet to a destination node of the first type; and
transmitting a first packet to the destination node of the first type along a route of nodes.

4. The method of claim 3 wherein the further comprising:
accumulating the route of nodes in the first packet.

5. The method of claim 4 wherein the first routing protocol comprises:
storing the route of nodes at a node of the first type; and
transmitting a second packet to a destination node of the second type based on the route of nodes.

6. The method of claim 5 wherein transmitting the second packet includes skipping one or more nodes along the route of nodes.

7. The method of claim 1 wherein the second routing protocol implements a gradient routing approach.

8. The method of claim 1 wherein the first routing protocol implements one or more of the approaches in the group consisting of:
a source routing approach;
a data flooding approach;
an ad hoc on-demand distance vector routing approach; and
a dynamic source routing approach.

9. A method for directing packets in a wireless mesh network, the method comprising:
storing a route of nodes at a source node in the network; and
transmitting a packet to a destination node in the network based on the route of nodes, including skipping one or more nodes along the route of nodes.

10. The method of claim 9 wherein a skipped node transmits an acknowledgement for the packet.

11. The method of claim 9 wherein a node not on the route redirects the packet after a node on the route fails to receive the packet.

12. A wireless mesh network comprising:
at least one node of a first type; and
a plurality of nodes of a second type;
wherein each node is configured to route packets from nodes of the first type to nodes of the second type using a first routing protocol; and
route packet from nodes of the second type to nodes of the first type using a second routing protocol that differs from the first routing protocol.

13. The network of claim 12 wherein there are more nodes of the second type than nodes of the first type.

14. The network of claim 12 wherein the second routing protocol comprises:
storing a cost associated with sending a packet to a destination node of the first type; and
transmitting a first packet to the destination node of the first type along a route of nodes.

15. Software stored on a computer-readable medium for directing packets in a wireless mesh network that includes nodes of a first type and nodes of a second type, comprising instructions for causing a processor to:
route packets from nodes of the first type to nodes of the second type using a first routing protocol; and
route packet from nodes of the second type to nodes of the first type using a second routing protocol that differs from the first routing protocol.

16. The software of claim 15 wherein the network includes more nodes of the second type than nodes of the first type.

17. The software of claim 15 wherein the second routing protocol comprises:
storing a cost associated with sending a packet to a destination node of the first type; and
transmitting a first packet to the destination node of the first type along a route of nodes.
